(19) United States
(12) Patent Application Publication
(10) Pub. No.: US 2008/0092932 A1
(43) Pub. Date: Apr. 24, 2008

(54) Steam cleaning appliance

(75) Inventor: Siu Chun Tam, Hong Kong (CN)

Correspondence Address: BIRCH STEWART KOLASCH & BIRCH, PO BOX 747, FALLS CHURCH, VA, 22040-0747, US

(73) Assignee: Johnson Electric S.A.

(21) Appl. No.: 11/907,937

(22) Filed: Oct. 18, 2007

(30) Foreign Application Priority Data
Oct. 20, 2006 (GB) 0620857.3

(51) Int. Cl. B08B 3/00

(52) U.S. Cl. 134/105

(57) ABSTRACT

A portable domestic steam cleaner has a housing accommodating a releasable water tank. A pump transfers water from the tank to a boiler for generating steam. In use, steam exits a nozzle for cleaning etc. A pump suitable for use in the steamer is also disclosed.

### CROSS-REFERENCE TO RELATED APPLICATIONS

This non-provisional patent application claims priority under 35 U.S.C. §119(a) from Patent Application No. 0620857.3 filed in Great Britain on 20 Oct. 2006.

### BACKGROUND OF THE INVENTION

1. Field of the Invention

The invention relates to steam cleaning appliances and in particular to portable steam cleaners, especially for domestic use.

2. Description of Prior Art

Steam cleaning appliances are well known, including small portable appliances used for general cleaning, de-greasing and sterilizing. They generally have a steam generator in the form of a heater or boiler supplied with water from an enclosed water tank by a small solenoid pump. While this is satisfactory for a basic appliance, there are inherent disadvantages resulting from this design. The solenoid pump either operates at one speed or requires complex electronic circuitry to change the frequency of the incoming power supply to operate at a different speed as the speed of a solenoid pump is linked to the frequency of the driving power. With only a single speed, the supply of water to the boiler and thus the steam generator is not controllable. The steamer first heats up the boiler and then water is added at a constant rate into the boiler which lowers the temperature of the boiler, reducing the temperature of the steam produced. During delivery along the outlet tube from the boiler, the steam has a tendency to cool down and condenses, the cooler the boiler the faster the steam condenses.

### SUMMARY OF THE INVENTION

It is an object of the invention to overcome or at least reduce these problems.

Accordingly, in one aspect thereof, the invention provides a portable steam cleaner comprising: a housing having a handle and a nozzle, the handle accommodating: a tank for storing water; a boiler for generating steam and connected to the nozzle by a steam pathway; and a pump for transferring water from the tank to the boiler, wherein the pump is a motor driven pump.

Preferably, the motor is a variable speed motor.

Preferably, the motor is a HVDC permanent magnet motor controlled by a variable voltage speed controller.

Preferably, the speed controller is a variable resistor.

Preferably, the motor driven pump is a peristaltic pump or a gear pump.

Preferably, the pump is controllable to vary the rate of flow of water from the tank to the boiler.

Preferably, the rate of flow is variable between a minimum flow and a maximum flow.

Preferably, the rate of flow is continuously variable.

Preferably, the pump is a peristaltic pump which has a resiliently collapsible tube forming a part of the passageway for water from the tank to the boiler, and the tube is resiliently deformed by a number of rollers driven by the motor and respectively rolled in one direction along a section of the tube.

Preferably, each roller has an integral gear portion which meshes with a pinion fitted to the motor shaft.

Preferably, the rollers are fixedly spaced with respect to each other by a gear carrier, having axles about which the rollers are rotatable.

Preferably, the gear carrier is fitted to an end of the motor shaft by a bearing.

Preferably, the boiler has a plurality of heating elements and a number of the heating elements are used to vary the voltage supplied to the motor.

Preferably, the boiler has a plurality of heating elements and the speed of the pump is varied in concert with the heating of the boiler.

### BRIEF DESCRIPTION OF THE DRAWINGS

A preferred embodiment of the present invention will now be described, by way of example only, with reference to the accompanying drawings, in which:

FIG. 1 is a schematic sectional side view of a preferred portable steam cleaner;

FIG. 2 illustrates a variable speed motor driven pump, being a preferred pump for the steamer of FIG. 1;

FIG. 3 is an exploded view of the pump of FIG. 2;

FIG. 4 is a partial sectional view of the pump of FIG. 2;

FIG. 5 is a perspective view of a pump body, being a part of the pump of FIG. 2;

FIG. 6 is a perspective view of a first gear carrier, being a part of the pump of FIG. 2;

FIG. 7 is a perspective view of an upper cap, being a part of the pump of FIG. 2: and

FIG. 8 is a perspective view of an alternative pump for the steamer of FIG. 1.

### DETAILED DESCRIPTION OF THE PREFERRED EMBODIMENTS

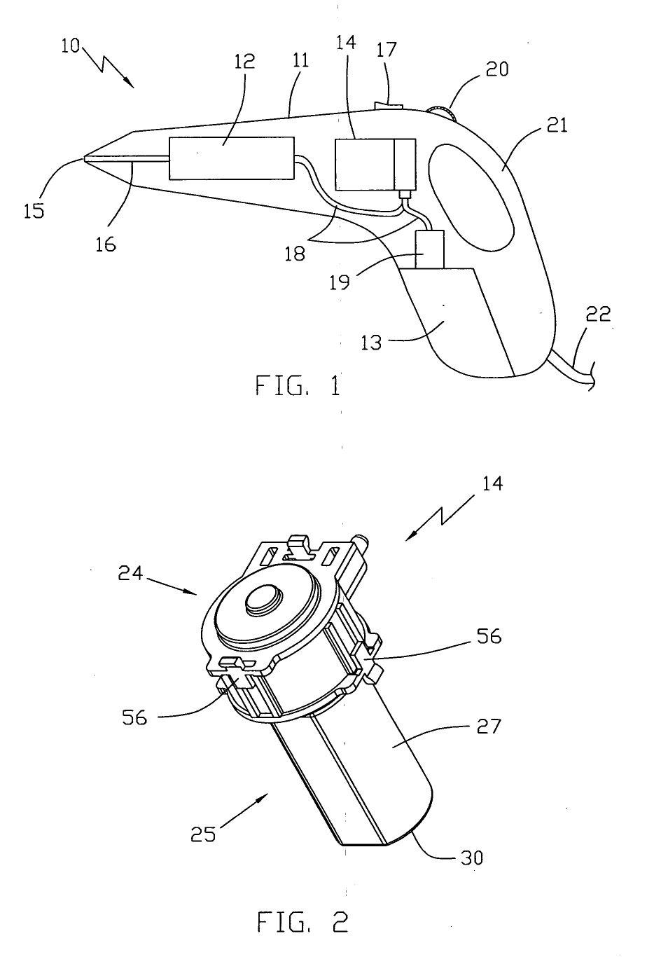

The schematic illustration of FIG. 1 shows a portable steam cleaner 10, of the handheld pistol type. The cleaner 10 is a self-contained unit having a housing 11 accommodating a boiler 12, a tank 13 for water, and a motor driven pump 14 for feeding water from the tank 13 to the boiler 12. Boiler 12 has a heater arranged to heat water received in a chamber of the boiler to turn the water into steam. Steam is passed from the boiler 12 to a nozzle or outlet 15, via a steam pathway 16. The heater may have one or more heating elements and optionally, the elements are able to be selectively turned on to vary the heating capacity and heating time of the boiler. A selector switch may be operated by a user or the elements may be automatically switched by a temperature sensor means, such as a thermostat. Optionally, the speed of the motor is variable to match the heating of the boiler.

A switch 17 for turning the cleaner on or off may be provided with several positions to select a desired heating or operational mode, such as OFF, LOW, MEDIUM, HIGH. Alternatively, not shown, separate switches could be employed for power and heater settings.

The tank 13 is shown as being fully enclosed within the housing 11 but could be partially enclosed or even mounted externally of the housing. Water is transferred to the boiler 12 through passageways or tubes 18. Optionally, a filter 19 to remove debris or particulate matter in the water may be fitted to the water delivery lines or passageways 18.

The pump 14 is a motor driven pump, which draws water from the tank 13 through the filter 19, if fitted, to supply the boiler 12. The motor of the pump is, preferably, a permanent magnet direct current (PMDC) motor, optionally a high voltage direct current motor running on rectified mains supply. Alternatively, the motor may be connected in series with a heating element to lower the motor operating voltage.

Optionally, the motor speed is variable, to vary the flow rate of water to the boiler. This speed variation is relatively simple for a PMDC motor, as the speed is dependent on supply voltage. Thus a rudimentary control system may be to add additional resistance to the motor circuitry, such as by adding extra heating elements in series with the motor to further reduce the supply voltage, and thus to the motor speed.

Alternately, the motor may be supplied with its own supply voltage through a separate controller. Thumb wheel switch 20 shown mounted along a handle portion 21 of the housing 11 for easy access by user, may control the output of the controller to the motor to vary the motor speed. This arrangement can be used for other types of motors, including a universal type motor or a brushless DC motor. Optionally and preferred, the motor may be supplied with a low voltage DC power derived from the main supply and supplied to the motor via a variable resistor operated by rotation of the thumb wheel switch 20 to vary the resistance of the motor circuit, thus varying the speed of the motor. Alternatively, a standard simple motor speed controller may be used.

Mains power is applied to the cleaner via a power cord, here symbolically referred to by reference numeral 22.

The preferred pump is shown in FIG. 2. The pump 14 has a pump portion 24, driven by a variable speed motor, such as a PMDC motor 25. In the preferred embodiment, the pump portion 24 is a peristaltic pump.

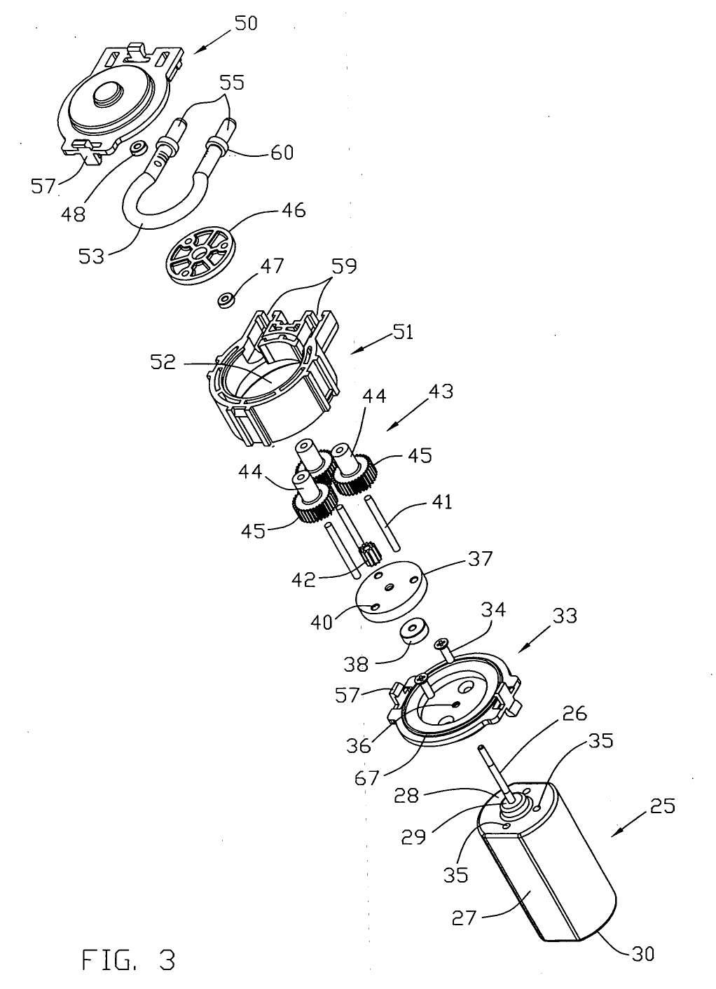

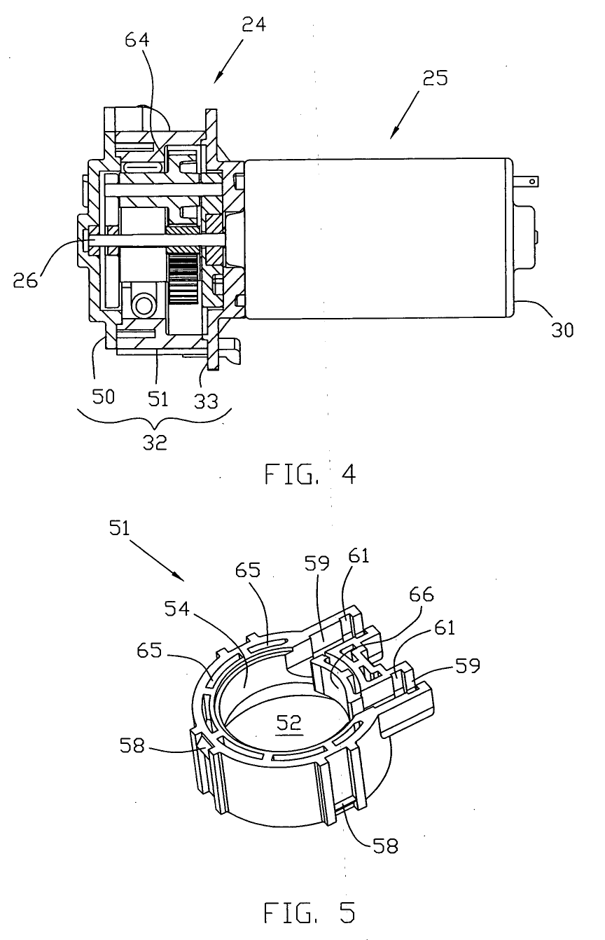

FIG. 3 shows the pump 14 exploded, while FIG. 4 shows the pump 14 partially sectioned. Starting from the bottom of the pump 14 as shown in FIG. 3, the motor 25 is shown with a motor shaft 26 extending upwardly. The motor has a deep drawn metal housing 27 having an upper closed end 28 having a boss 29 formed therein for receiving a bearing (not shown) in which the motor shaft 26 is journalled (rotatably mounted). The lower end of the motor housing 27 is open and is closed by an end bracket 30 supporting a second bearing for the shaft 26.

A pump housing 32 is fixed to the upper closed end 28 of the motor housing 27. A lower cap 33 of the pump housing 32 is held by two screws 34 which are screwed into threaded holes 35 in the upper end 28 of the motor housing 27. The shaft 26 extends through a hole 36 in the lower cap 33.

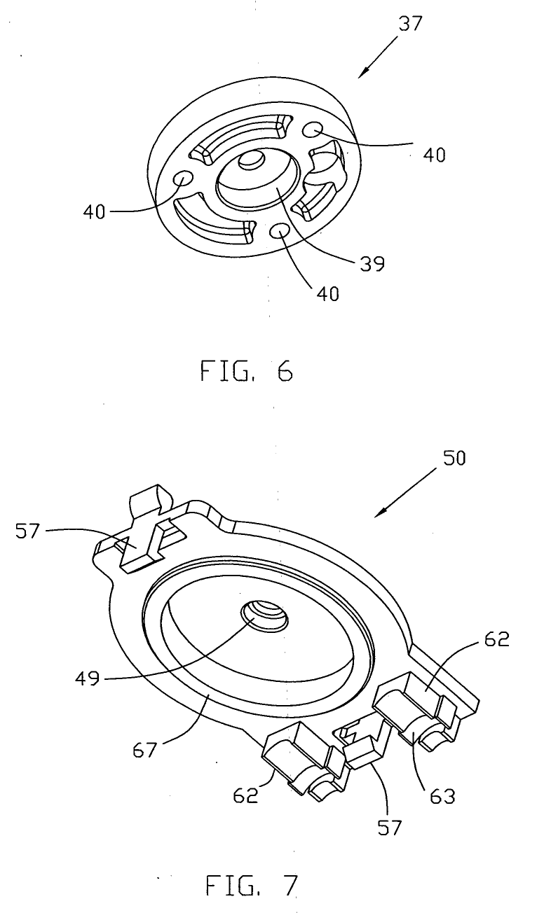

A first gear carrier 37 is fitted to the shaft 26, by way of a first gear bearing 38. First gear carrier 37 is shown enlarged and from a lower angle in FIG. 6, which reveals a central cavity 39 forming a recess for receiving the first gear bearing 38. The first gear carrier has three holes 40 equidistantly circumferentially spaced in which three axles 41 are fitted, as a press fit. A pinion 42 is pressed onto the shaft 26 and locates adjacent an upper surface of the first gear carrier 37. Each axle 41 rotatably supports a respective roller 43. Each roller 43 has a cylindrical roller portion 44 and a lower gear portion 45, the gear portion 45 having a greater radial extent than the roller portion 44. The gear portion 45 of each roller 43 is in mesh with the pinion 42. Thus as the motor shaft 26 turns, the pinion 42 turns, driving each roller 43.

A second gear carrier 46 is fitted to the upper end of the axles 41 above the rollers 43 to support keep the upper ends of the axles 41 in fixed spaced relationship. The second gear carrier 46 also has a second gear bearing 47 for rotatably supporting the second gear carrier 46 on the shaft 26.

A further bearing 48 supports the distal end of the shaft 26 in a cavity 49 of an upper cap 50 of the pump housing 32. Between the upper cap 50 and the lower cap 33 is a pump body 51. The pump body 51 has an inner cavity 52, which accommodates the rollers 43 and a tube 53 of resilient flexible material is located extending circumferentially along a significant portion of the inner surface of the cavity 52, in this example, approximately 270°. The pump body 51 and the rollers 43 are arranged such that the tube 53 is compressed at points between the rollers 43 and the wall 54 of the cavity 52.

The tube 53 is formed with or is connected to connectors 55 forming the inlet and outlet. Which connector is the inlet depends on the direction of rotation of the rollers 43.

The pump body 51 is connected to the upper and lower caps 50, 33, by snap lock connections indicated generally by reference numeral 56 for easy assembly and disassembly. Disassembly allows a tube to be replaced easily. The snap lock connections 56 preferably, as shown in this example, comprised flexible fingers 57 formed on the caps 33, 50 which extend over and lock onto stops 58 formed on the pump body 51. The tube 53 extends along a generally curved or arcuate portion of the inner surface of the wall 54 of the pump body 51. The tube 53 is held in place by passing through slots 59 in the wall 54, allowing the tube 53 or preferably the connectors 55 at the ends of the tube 53 to extend out of the pump body 51 to connect with other tubes or hoses.

Preferably, the connectors 55 have a flange 60 which locates in a groove 61 extending transversely of the slot 59 for capturing the connector 55 within the slot 59. The open top of each slot 59 is closed by a slot projection 62 on the upper cap 50 which also has a corresponding recess 63 for receiving a part of the flange 61 of the connector 55, as shown in FIG. 7.

Preferably, the connectors 55 are separate items which are pressed into the ends of the tube 53 and the ends of the tube are clamped to the connectors 55 via the slots 59 and the slot projections 62 on the upper cap 50.

As shown more clearly in FIG. 4, the inner surface of the wall 54 of the pump body 51 is stepped allowing the gear portion 45 of the rollers 43 to extend outwardly under the step 64. The stepped portion forms the wall which contacts the tube 53. Blind apertures 65 may be formed in the wall 54 of the pump body, adjacent to the tube contact portion. A short arcuate portion 66 may be provided between the slots 59 in the wall 54 to support the rollers 43 where there is no tube, to reduce the radial stress on the motor shaft 26.

Lips 67 on the upper and lower caps align the caps 33, 50 with the pump body 5 1, and thus the pump housing 32 with the motor 25. As may be appreciated, the pump housing comprises the pump body and the upper and lower caps. Optionally, shaft 26 may have one or more steps to ease assembly, especially the fitting of the pinion 42.

In use, as the rollers are driven by the motor the rollers roll along the tube causing the tube to be compressed in an ever advancing sequence. The compression of the tube causes localised sealing of the tube or spot seals forming sealed compartments between successive compression points, and as the rollers roll along the tube, the sealed compartments, and their contents are progressively moved along the tube from inlet to outlet.

The last compression point forms an open ended compartment until the next roller in sequence contacts and compressors the tube to form a new “fast” compression point and seals the chamber in front, while forming a new open chamber at the inlet. At the outlet, as a roller breaks contact with the tube, the first compartment in the sequence opens up pushing its contents out through the outlet.

The use of a variable speed motor driven pump for providing the flow of water from the tank to the boiler in a portable steam cleaner allows a user to vary the amount of steam being generated or used for a particular application at the user's choice. The peristaltic pump described provides a very useful motor driven pump for use in such an application.

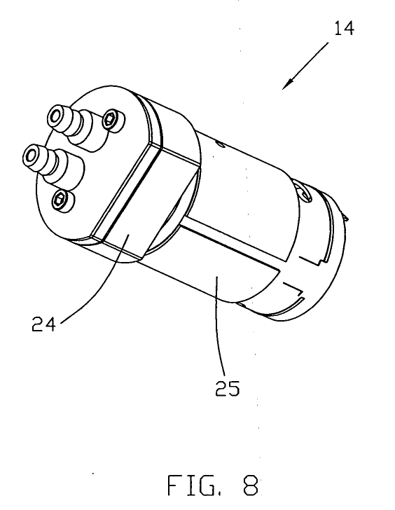

FIG. 8 illustrates an alternative pump 14 for use with the steamer. In this embodiment the pump 24 has a the pump portion 24 in the form of a gear pump, driven by a permanent magnet direct current (PMDC) motor 25. As such the motor is a variable speed motor and the pump output depends on the speed of the motor. Alternatively, the motor could be a brushless DC motor or any other suitable variable speed motor. The brushless motor has an advantage of longer life due to the absence of brushes but the cost of the controller which replaces the brushes adds to the total cost of the motor. This is often a barrier to using a brushless motor but in this case the cost may be acceptable as there is a need for a controller to vary the speed of the motor which can be handled by the brushless motor controller.

The embodiments described above, are given by way of examples only and various modifications will be apparent to persons skilled in the art without departing from the spirit of the invention as defined by the appended claims.

1. A portable steam cleaner comprising:
a housing having a handle and a nozzle;
the handle accommodating:
a tank for storing water;
a boiler for generating steam and connected to the nozzle by a steam pathway; and
a pump for transferring water from the tank to the boiler,
characterised in that the pump is a motor driven pump.

2. The portable steam cleaner of claim 1, wherein the motor is a variable speed motor.

3. The portable steam cleaner of claim 2, wherein the motor is a high voltage DC permanent magnet motor controlled by a variable voltage speed controller.

4. The portable steam cleaner of claim 3, wherein the speed controller is a variable resistor.

5. The portable steam cleaner of claim 1, wherein the motor driven pump is a peristaltic pump or a gear pump.

6. The portable steam cleaner of claim 1, wherein the pump is controllable to vary the rate of flow of water from the tank to the boiler.

7. The portable steam cleaner of claim 6, wherein the rate of flow is variable between a minimum flow and a maximum flow.

8. The portable steam cleaner of claim 7, wherein the rate of flow is continuously variable.

9. The portable steam cleaner of claim 1, wherein the pump is a peristaltic pump which has a resiliently collapsible tube forming a part of the passageway for water from the tank to the boiler, and the tube is resiliently deformed by a number of rollers driven by the motor and respectively rolled in one direction along a section of the tube.

10. The portable steam cleaner of claim 9, wherein each roller has an integral gear portion which meshes with a pinion fitted to the motor shaft.

11. The portable steam cleaner of claim 9, wherein the rollers are fixedly spaced with respect to each other by a gear carrier, having axles about which the rollers are rotatable.

12. The portable steam cleaner of claim 11, wherein the gear carrier is fitted to an end of the motor shaft by a bearing.

13. The portable steam cleaner of claim 1, wherein the boiler has a plurality of heating elements and a number of the heating elements are used to vary the voltage supplied to the motor.

14. The portable steam cleaner of claim 1, wherein the boiler has a plurality of heating elements and the speed of the pump is varied in concert with the heating of the boiler.
